(19) United States
(12) Patent Application Publication
(10) Pub. No.: US 2010/0073451 A1
(43) Pub. Date: Mar. 25, 2010

(54) METHOD, SYSTEM, AND APPARATUS FOR CONVERTING SURFACE PROPERTIES AND RECORDED MATERIAL

(75) Inventor: Tsuyoshi Sano, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/563,867

(22) Filed: Sep. 21, 2009

(30) Foreign Application Priority Data
Sep. 22, 2008 (JP) 2008-242340

(51) Int. Cl. B41J 2/01; B42D 15/00

(52) U.S. Cl. 347/105; 283/85

(57) ABSTRACT

A method for converting surface properties includes recording a concealing image on a recording medium using an ink composition containing hollow resin particles; and converting the concealing image into an image with decreased concealing capability by breaking the hollow resin particles contained in the concealing image.

### BACKGROUND

1. Technical Field

The present invention relates to methods for changing the surface properties of, for example, recording media (including both blank recording media and recording media having any image recorded thereon in advance) partially or in their entirety, and particularly to a method for partially changing the surface properties of a recording medium having any image formed thereon in advance.

2. Related Art

White ink compositions containing hollow resin particles are known (see, for example, U.S. Pat. No. 4,880,465, JP-A-2000-103995, JP-A-2000-239585, and JP-A-2005-154568). These hollow resin particles include inner cavities and outer shells formed of a liquid-permeable resin. With this structure, the inner cavities of the hollow resin particles are filled with the solvent in the ink composition so that the particles have substantially the same specific gravity as the ink composition. This allows the hollow resin particles to be stably dispersed in the ink composition. When the ink composition is used to form an image on a recording medium, air replaces the solvent in the inner spaces of the hollow resin particles after drying. The hollow resin particles thus provide a concealing effect resulting from light scattering due to the difference in refractive index between the outer shells and the cavities (that is, they look white). Typically, the hollow resin particles themselves are formed of a transparent resin such as acrylic resin.

A variety of improvements have been made on such hollow resin particles. Japanese Patent No. 3,639,479, for example, discloses a method for improving the heat resistance of hollow resin particles (hollow microspheres), which decolorize a white print (exhibit decreased whiteness) when softening at high temperatures of not lower than 120°.

Also known is a method (overprint varnishing) of forming a pattern on a surface of a recorded material having any image formed thereon using, for example, a resin or a resin containing a matt agent to change surface glossiness in the treated region, thereby enhancing a print effect. The resin used to form the pattern is, for example, a transparent ultraviolet-curable resin, polypropylene, or a resin varnish. A variety of methods for forming such a pattern have been studied.

JP-A-11-174758, for example, discloses an image-forming apparatus including a rotatable fusing unit that fuses a toner image formed on a transfer material and a wax-droplet supplying unit that supplies melted wax droplets onto the transfer material after the fusion. This image-forming apparatus reads a glossy-image region in the original in advance by preliminary scanning and applies melted wax into the glossy-image region in recording paper when fusing the toner deposited thereon, thus imparting glossiness.

JP-A-5-50027, on the other hand, discloses a method for imparting glossiness to a printed material by coating the printed material with an ultraviolet-curable resin varnish, laminating a mirror-finished transparent film on the coated surface of the printed material, irradiating the printed material with ultraviolet light through the film, and delaminating the film from the printed material. According to the above publication, this method improves the flatness of the coated surface.

In addition, there is a growing demand for spot varnishing, which partially changes the surface properties of a recorded material having any image formed thereon, such as a printed material. The term “surface properties” herein encompasses properties such as glossiness, a stereoscopic effect, and surface smoothness. While the surface properties can be changed by directly imparting such properties to the recorded material, they can also be changed by texture expression, which depends on different human senses such as sight and touch. The texture expression provides various expressions; for example, changing the glossiness of the recorded material causes the viewer to perceive the recorded material differently in terms of stereoscopic effect or surface smoothness or to perceive the slight change in the thickness of the recorded material as being larger than it actually is in synergy with visually perceived glossiness when touching the recorded material.

The growing demand for spot varnishing has resulted in a demand for a novel method that allows the surface properties of a recorded material to be partially changed in a convenient manner.

### SUMMARY

An advantage of some aspects of the invention is that it provides a convenient method for changing the surface properties of a recording medium partially or in its entirety, particularly, a method for partially changing the surface properties of a recording medium having any image formed thereon.

The inventor has made an intensively study focusing on the heat resistance of hollow resin particles showing a color such as white by a concealing effect resulting from light scattering due to the difference in refractive index between outer shells and cavities. As a result, the inventor has found that a concealing image formed on a recording medium using an ink composition containing such hollow resin particles as above has glossiness after the hollow resin particles contained in the concealing image are broken by a method such as heating to decrease the concealing capability thereof. This is because the hollow resin particles lose the concealing effect resulting from light scattering after the inner cavities collapse and contract as a result of breakage, thus showing glossiness due to the intrinsic transparency of the resin. Thus, the image with decreased concealing capability is substantially transparent and, when applied to a recording medium having any image recorded thereon in advance, does not conceal the underlying image.

The inventor has also found that the image with decreased concealing capability, provided by breaking the hollow resin particles, has a stereoscopic effect. The stereoscopic effect herein refers to a texture that causes the viewer to perceive the change in the thickness of the portion having the image with decreased concealing capability as being larger than it actually is in synergy with visually perceived glossiness when touching the recorded material. The above stereoscopic effect can be provided because the inner cavities of the hollow resin particles are caused to collapse and contract by a method such as heating to disturb the arrangement order of the hollow resin particles and binder resin, for example, forming the concealing image.

Based on the above findings, the inventor has concluded that the surface properties of a recording medium can be changed partially or in its entirety by a convenient method, particularly, that the surface properties of a recording medium having any image formed thereon can be partially changed by a convenient method, thus completing the invention.

A method for converting surface properties according to a first aspect of the invention includes recording a concealing image on a recording medium using an ink composition containing hollow resin particles; and converting the concealing image into an image with decreased concealing capability by breaking the hollow resin particles contained in the concealing image.

In the above method for converting surface properties, the recording medium may have any image recorded thereon in advance.

In the above method for converting surface properties, the concealing image may be partially recorded at any position on the recording medium.

In the above method for converting surface properties, the image with decreased concealing capability may have glossiness.

In the above method for converting surface properties, the hollow resin particles may be broken by heating.

In this case, the heating temperature may be 100° C. to 200° C.

In the above method for converting surface properties, the image with decreased concealing capability formed on the recording medium may have a stereoscopic effect.

In the above method for converting surface properties, the concealing image may be recorded by ink-jet recording.

A recorded material may be provided by the above method for converting surface properties.

A system for converting surface properties according to a second aspect of the invention includes a concealing-image forming unit that forms a concealing image on a recording medium using an ink composition containing hollow resin particles; and a hollow-resin-particle breaking unit that breaks the hollow resin particles contained in the concealing image.

An apparatus for converting surface properties according to a third aspect of the invention integrally includes a concealing-image forming unit that forms a concealing image on a recording medium using an ink composition containing hollow resin particles; and a hollow-resin-particle breaking unit that breaks the hollow resin particles contained in the concealing image.

According to the above method for converting surface properties, the surface properties of a recording medium can be changed in a convenient manner using, for example, a general-purpose white ink composition containing white hollow resin particles and a general-purpose ink jet recording device. This method is particularly suitable as a technique for spot varnishing, which has increasingly been demanded, in partially imparting properties such as glossiness and a stereoscopic effect to a recording medium having any image recorded thereon in advance without concealing the underlying image (that is, while maintaining the color of the underlying image). Thus, this method broadens the horizons of image expression.

### DESCRIPTION OF EXEMPLARY EMBODIMENTS

A method, system, and apparatus for converting surface properties and a recorded material according to an embodiment of the invention will now be described in detail.

The method for converting surface properties according to the embodiment of the invention includes a first step of recording a concealing image on a recording medium using an ink composition containing hollow resin particles and a second step of converting the concealing image into an image with decreased concealing capability by breaking the hollow resin particles contained in the concealing image. For example, if a white ink composition containing white hollow resin particles is used, the method includes a first step of recording a white image with high concealing capability on a recording medium and a second step of converting the white image into an image with decreased whiteness by breaking the hollow resin particles contained in the white image.

The term “recording medium” herein encompasses both blank recording media and recording media having any image formed thereon in advance. The term “hollow resin particles” means hollow resin particles that show a color such as white by a concealing effect resulting from light scattering due to the difference in refractive index between outer shells and cavities. The term “concealing image” means an image formed using an ink composition containing hollow resin particles, as described above, that show a color such as white; it may be either an image completely concealing the underlying image or an image concealing the underlying image to such an extent that it is visible. The term “surface properties” refers to glossiness and/or a stereoscopic effect.

The method for converting surface properties according to this embodiment will now be described in detail, where a white ink composition containing hollow resin particles looking white by a concealing effect resulting from light scattering due to the difference in refractive index between outer shells and cavities is used as an example of the ink composition for recording the concealing image. It will be understood, however, that the hollow resin particles used may show a color other than white; for example, the resin constituting the hollow resin particles may be colored in another color. In such a case, the invention can be applied in the same manner as the embodiment, described below, using white hollow resin particles.

### White Ink Composition

### 1. Hollow Resin Particles

The hollow resin particles used in this embodiment preferably include inner cavities and outer shells formed of a liquid-permeable resin. With this structure, if the hollow resin particles are present in an aqueous ink composition, the inner cavities are filled with the aqueous solvent. Because the particles filled with the aqueous solvent have substantially the same specific gravity as the external aqueous solvent, dispersion stability can be maintained without settling out of the aqueous ink composition. This improves the storage stability and ejection stability of the white ink composition.

If the white ink composition according to this embodiment is ejected onto a recording medium such as paper, the aqueous solvent in the particles evaporates when dried, thus leaving empty cavities. The particles take in air that forms an air layer having a different refractive index as the resin layer. These layers effectively scatter incident light so that the particles look white.

The hollow resin particles used in this embodiment are not specifically limited and can be of a known type. For example, the hollow resin particles disclosed in the specifications of U.S. Pat. No. 4,880,465 and Japanese Patent No. 3,562,754 are suitable.

The hollow resin particles preferably have an average particle size (outer diameter) of 0.2 to 1.0 μm, more preferably 0.4 to 0.8 μm. If the outer diameter exceeds 1.0 μm, the particles may settle out, thus losing dispersion stability, and may also cause clogging of an ink jet recording head, thus impairing reliability. If the outer diameter falls below 0.2 μm, the ink composition tends to lack whiteness. The inner diameter, on the other hand, is preferably about 0.1 to 0.8 μm.

The average particle size of the hollow resin particles can be measured using a size distribution measurement apparatus that works on laser diffraction scattering. The laser-diffraction size distribution measurement apparatus used can be, for example, a size distribution meter that works on dynamic light scattering (for example, Microtrac UPA, manufactured by Nikkiso Co., Ltd.).

The content of the hollow resin particles (solid content) is preferably 5% to 20% by mass, more preferably 8% to 15% by mass, based on the total mass of the white ink composition. If the content of the hollow resin particles (solid content) exceeds 20% by mass, the particles may cause clogging of an ink jet recording head, thus impairing reliability. If the content falls below 5% by mass, the ink composition tends to lack whiteness.

The method for preparing the hollow resin particles is not specifically limited and can be a known one. For example, the hollow resin particles can be prepared by emulsification polymerization, in which a hollow resin particle emulsion is formed by stirring a mixture of a vinyl monomer, a surfactant, a polymerization initiator, and an aqueous dispersion medium in a nitrogen atmosphere while heating the mixture.

Examples of vinyl monomers include nonionic monoethylenically unsaturated monomers such as styrene, vinyltoluene, ethylene, vinyl acetate, vinyl chloride, vinylidene chloride, acrylonitrile, (meth)acrylamide, and (meth)acrylate esters. Examples of (meth)acrylate esters include methyl acrylate, methyl methacrylate, ethyl(meth)acrylate, butyl(meth)acrylate, 2-hydroxyethyl methacrylate, 2-ethylhexyl(meth)acrylate, benzyl(meth)acrylate, lauryl(meth)acrylate, oleyl (meth)acrylate, palmityl(meth)acrylate, and stearyl(meth)acrylate.

Examples of vinyl monomers also include bifunctional vinyl monomers such as divinylbenzene, allyl methacrylate, ethylene glycol dimethacrylate, 1,3-butanediol dimethacrylate, diethylene glycol dimethacrylate, and trimethylolpropane trimethacrylate. The above monofunctional vinyl monomers and the above bifunctional vinyl monomers can be copolymerized and highly crosslinked to form hollow resin particles with properties such as heat resistance, solvent resistance, and dispersibility in solvents in addition to light scattering properties.

The surfactant used may be any surfactant that forms molecular assemblies such as micelles in water, such as an anionic surfactant, a nonionic surfactant, a cationic surfactant, or an amphoteric surfactant.

The polymerization initiator used can be a known compound soluble in water, such as hydrogen peroxide or potassium persulfate.

The aqueous dispersion medium used is, for example, water or water containing a hydrophilic organic solvent.

### 2. White Ink Composition

The content of the hollow resin particles (solid content) in the white ink composition according to this embodiment is preferably 5% to 20% by mass, more preferably 8% to 15% by mass, based on the total mass of the ink composition. If the content of the hollow resin particles (solid content) exceeds 20% by mass, the particles may, for example, cause clogging of an ink jet recording head, serving as a white-image forming unit, thus impairing reliability. If the content falls below 5% by mass, the ink composition tends to lack whiteness.

The white ink composition according to this embodiment contains a resin serving as a binder for the hollow resin particles. Such resins include acrylic resins (for example, Almatex (manufactured by Mitsui Chemicals, Inc.)) and urethane resins (for example, WBR-022U (manufactured by Taisei Fine Chemical Co., Ltd.)).

The content of the binder resin is preferably 0.5% to 1.0% by mass, more preferably 0.5% to 3.0% by mass, based on the total mass of the ink composition.

The white ink composition according to this embodiment preferably contains at least one material selected from the group consisting of alkanediols and glycol ethers. Alkanediols and glycol ethers improve wettability for recording surfaces of recording media and therefore ink permeability.

As examples of alkanediols, 1,2-alkanediols having four to eight carbon atoms are preferable, including 1,2-butanediol, 1,2-pentanediol, 1,2-hexanediol, 1,2-heptanediol, and 1,2-octanediol. Among them, those having six to eight carbon atoms, including 1,2-hexanediol, 1,2-heptanediol, and 1,2-octanediol, are more preferable because they have particularly high permeability to recording media.

Examples of glycol ethers include lower alkyl ethers of polyalcohols such as ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, dipropylene glycol monomethyl ether, dipropylene glycol monoethyl ether, triethylene glycol monomethyl ether, triethylene glycol monobutyl ether, and tripropylene glycol monomethyl ether. Among them, the use of triethylene glycol monobutyl ether provides superior recording quality.

The content of at least one material selected from the group consisting of alkanediols and glycol ethers is preferably 1% to 20% by mass, more preferably 1% to 10% by mass, based on the total mass of the ink composition.

In addition, the white ink composition according to this embodiment preferably contains an acetylene glycol surfactant or a polysiloxane surfactant. Acetylene glycol surfactants and polysiloxane surfactants improve wettability for recording surfaces of recording media and therefore ink permeability.

Examples of acetylene glycol surfactants include 2,4,7,9-tetramethyl-5-decyne-4,7-diol, 3,6-dimethyl-4-octyne-3,6-diol, 3,5-dimethyl-1-hexyn-3-ol, and 2,4-dimethyl-5-3-ol. In addition, commercially available products of acetylene glycol surfactants can be used, including Olfine E1010, STG, and Y (manufactured by Nissin Chemical Industry Co., Ltd.) and Surfynol 104, 82, 465, 485, and TG (manufactured by Air Products and Chemicals, Inc.).

As examples of polysiloxane surfactants, commercially available products such as BYK-347 and BYK-348 (manufactured by BYK Japan KK) can be used.

In addition, the white ink composition according to this embodiment may contain another surfactant such as an anionic surfactant, a nonionic surfactant, or an amphoteric surfactant.

The content of the surfactant is preferably 0.01% to 5% by mass, more preferably 0.1% to 0.5% by mass, based on the total mass of the ink composition.

The white ink composition according to this embodiment preferably contains a polyalcohol. If the white ink composition according to this embodiment is applied to an ink jet recording device, the polyalcohol inhibits ink from drying at an ink-jet recording head, thus preventing ink clogging.

Examples of polyalcohols include ethylene glycol, diethylene glycol, triethylene glycol, polyethylene glycol, polypropylene glycol, propylene glycol, butylene glycol, 1,2,6-hexanetriol, thioglycol, hexylene glycol, glycerol, trimethylolethane, and trimethylolpropane.

The content of the polyalcohol is preferably 0.1% to 3.0% by mass, more preferably 0.5% to 20% by mass, based on the total mass of the ink composition.

The white ink composition according to this embodiment preferably contains a tertiary amine, which functions as a pH adjuster to facilitate pH adjustment of the ink composition.

An example of a tertiary amine is triethanolamine.

The content of the tertiary amine is preferably 0.01% to 10% by mass, more preferably 0.1% to 2% by mass, based on the total mass of the ink composition.

The white ink composition according to this embodiment usually contains water as a solvent. The water used is preferably pure or ultrapure water such as ion-exchanged water, ultrafiltered water, reverse osmosis water, or distilled water. It is particularly preferable to sterilize such water by, for example, ultraviolet irradiation or addition of hydrogen peroxide because it inhibits occurrence of fungi and bacteria over an extended period of time.

In addition, the white ink composition according to this embodiment may optionally contain other additives, including a binder such as water-soluble rosin, a fungicide/preservative such as sodium benzoate, an antioxidant/ultraviolet absorber such as an allophanate, a chelating agent, and an oxygen absorber. These additives can be used singly or in a combination of two or more.

The white ink composition according to this embodiment can be prepared in the same manner as known pigment inks using a known apparatus such as a ball mill, a sand mill, an attritor, a basket mill, or a roll mill. During the preparation, coarse particles are preferably removed through, for example, a membrane filter or a mesh filter.

### Method for Recording Concealing Image (White Image)

The method for recording a white image on a recording medium using the white ink composition according to this embodiment is not specifically limited; it can be applied to a variety of recording methods. Examples of recording methods include thermal ink-jet recording, piezoelectric ink-jet recording, continuous ink-jet recording, roller application, and spray application.

The amount of white ink composition ejected onto the recording medium is preferably 5 to 40 g/m², more preferably 10 to 25 g/m², in view of ensuring glossiness and a stereoscopic effect expressed on an image with decreased whiteness into which a white image is converted.

### Recording Medium

The material of the recording medium used in this embodiment is not specifically limited and may be, for example, paper, cardboard, fabric, sheets, films, plastic, glass, and ceramic.

Method for Conversion into Image with Decreased Concealing Capability (Image with Decreased Whiteness)

The white image recorded on the recording medium looks white as a result of a concealing effect due to the difference in refractive index between the outer shells of the hollow resin particles and the air phase formed in the inner cavities thereof after drying. In this embodiment, the white image is converted into an image with decreased whiteness showing glossiness due to the intrinsic transparency of the resin by breaking the hollow resin particles in the white image so that the inner cavities collapse and the hollow resin particles themselves contract. Although the image with decreased whiteness is substantially transparent, if the method according to this embodiment is applied to a recording medium having any image formed thereon in advance, the white image is preferably converted into a glossy image with sufficient transparency not to conceal the underlying image. The hollow resin particles, which are generally formed of a material such as acrylic resin, can be easily broken by heating or pressing, preferably at least by heating. In this embodiment, it is possible to record the white image only at a position where the surface properties are to be converted and convert the entire white image into an image with decreased whiteness. It is also possible to selectively convert part of the white image into an image with decreased whiteness and leave the rest as a white image on the recorded material.

The method for breaking the hollow resin particles is not specifically limited, and they may be broken by heating using a laminator, or using a device capable of heating or pressing, such as a laser, a heating iron, a dryer, an infrared heater, a ceramic heater, or a steam iron.

If the hollow resin particles are broken by heating, the temperature for heating the image-recorded surface is preferably 100° C. to 200° C., more preferably 120° C. to 180° C. If the heating temperature is 100° C. to 200° C., the recording medium can have both superior glossiness and a superior stereoscopic effect.

If the hollow resin particles are broken by pressing, they can be broken, for example, by inserting the recording medium into a hot press for simultaneous pressing and heating or by feeding it to a heated laminator.

### Recorded Material

According to this embodiment, a recorded material having an image formed thereon by the above method can be provided.

The image with decreased concealing capability is a substantially transparent glossy image that exhibits the intrinsic transparency of the resin forming the particles as a result of the decrease in concealing capability. This image does not conceal the underlying image when formed on a recording medium having any image formed thereon. According to this embodiment, therefore, a recorded material can be provided on which only the surface properties, such as glossiness and stereoscopic effect, of the underlying image have been changed while the color thereof is maintained.

### System and Apparatus for Converting Surface Properties

According to this embodiment, there is provided a system for converting surface properties that includes a concealing-image forming unit that forms a concealing image on a recording medium using the above ink composition containing the hollow resin particles and a hollow-resin-particle breaking unit that breaks the hollow resin particles contained in the concealing image. As the hollow-resin-particle breaking unit, the system for converting surface properties may include, for example, a unit, as described above, that can heat or press the hollow resin particles to such an extent that they are broken.

The system for converting surface properties according to this embodiment may be either an apparatus integrally including the concealing-image forming unit and the hollow-resin-particle breaking unit or an apparatus including the two units as separate units (for example, the system may perform recording using an ink-jet recording device and heating using a separate laminator).

### EXAMPLES

The invention will be described in more detail with reference to the examples below, although they do not limit the invention.

First, white ink compositions (inks 1 and 2) containing white hollow resin particles were prepared according to the compositions shown in Table 1, where the values are expressed in percent by mass.

TABLE 1

| | | Ink 1 | Ink 2 |
|---|---|---|---|
| 1 | White hollow resin particles (solid content) | 10 | 10 |
| 2 | Polyurethane emulsion | 5 | — |
| | (solid content: 30%; Tg: 25° C.) | | |
| 3 | Polyurethane emulsion | — | 5 |
| | (solid content: 31%; Tg: 20° C.) | | |
| 4 | Glycerol | 10 | 10 |
| 5 | 1,2-hexanediol | 3 | 3 |
| 6 | Triethanolamine | 0.5 | 0.5 |
| 7 | Water | Balance | Balance |

1. “SX8782(D)”, manufactured by JSR Corporation; outer diameter: 1.0 μm; inner diameter 0.8 μm; water-dispersed type
2. “W-6061”, manufactured by Mitsui Chemicals, Inc.; particle size: 100 nm
3. “WBR-022U”, manufactured by Taisei Fine Chemical Co., Ltd.

Next, solid printing was performed on recording media using a black ink. The recording media used were photographic paper (manufactured by Seiko Epson Corporation).

Subsequently, some characters were recorded on the recording paper using a printer loaded with the white inks having the above compositions such that white characters were recorded on the black background.

The recording paper having the white images formed thereon was fed to a commercially available laminator (JOL-DIGITAL-4R, available from Japan Office Laminator Co., Ltd.). The recording paper was fed to the laminator, which is capable of temperature adjustment, with varying temperatures, namely, 90° C., 110° C., 150° C., 190° C., and 220° C. In addition, a sample subjected to solid printing using the black ink but having no white image formed thereon (“No white image” in Table 2) was prepared.

After the heating, L* values were measured at the character positions. The color measurement was performed by placing the printed materials on standard black paper for measurement using “938 Spectrodensitometer” (manufactured by X-rite, Inc), where the light source used was D50. The lightness (L*) thus measured was used as a measure of whiteness.

A higher L* value indicates a higher whiteness, and a lower L* value indicates a higher blackness (that is, a lower L* value indicates a higher character transparency). In addition, variations in L* value indicate relative variations in surface properties. The results are shown in Table 2.

In addition, a tactile test by a viewer was performed to evaluate variations in stereoscopic effect with respect to the following evaluation criteria. The results are shown in Table 2.

The evaluation criteria for stereoscopic effect are as follows:

AA: The surface had a stereoscopic effect, and was smooth and very glossy.

A: The surface had a stereoscopic effect, and was smooth.

B: The surface had a stereoscopic effect, but was slightly irregular.

C: The surface was coarse rather than having a stereoscopic effect.

TABLE 2

| | | | | | | | | No white |
|---|---|---|---|---|---|---|---|---|
| | Temperature (° C.) | Unheated | 90 | 110 | 150 | 190 | 220 | image |
| Ink 1 | L* value | 42.85 | 27.6 | 15.1 | 14.2 | 12.9 | 8.3 | 4.5 |
| | Stereoscopic effect | C | C | A | A | AA | B | — |
| Ink 2 | L* value | 57.23 | 31.4 | 19.2 | 16.3 | 13.1 | 7.9 | 4.5 |
| | Stereoscopic effect | C | C | B | A | A | B | — |

The results in Table 2 show that the characters on the paper fed to the laminator lost whiteness and became glossy and transparent. The characters on the paper fed at low temperature (90° C.), however, looked slightly white and seemed to have a lower quality than the paper fed above 100° C. In addition, when the laminator temperature was increased to 220° C., the characters became more transparent but had a lower stereoscopic effect, and the difference in surface properties between the characters and the black background was not noticeable.

What is claimed is:

1. A method for converting surface properties, comprising:
recording a concealing image on a recording medium using an ink composition containing hollow resin particles; and
converting the concealing image into an image with decreased concealing capability by breaking the hollow resin particles contained in the concealing image.

2. The method for converting surface properties according to claim 1, wherein the recording medium has any image recorded thereon in advance.

3. The method for converting surface properties according to claim 1, wherein the concealing image is partially recorded at any position on the recording medium.

4. The method for converting surface properties according to claim 1, wherein the image with decreased concealing capability has glossiness.

5. The method for converting surface properties according to claim 1, wherein the hollow resin particles are broken by heating.

6. The method for converting surface properties according to claim 5, wherein the heating temperature is 100° C. to 200° C.

7. The method for converting surface properties according to claim 1, wherein the image with decreased concealing capability formed on the recording medium has a stereoscopic effect.

8. The method for converting surface properties according to claim 1, wherein the concealing image is recorded by ink-jet recording.

9. A recorded material provided by the method for converting surface properties according to claim 1.

10. A system for converting surface properties, comprising:
a concealing-image forming unit that forms a concealing image on a recording medium using an ink composition containing hollow resin particles; and
a hollow-resin-particle breaking unit that breaks the hollow resin particles contained in the concealing image.

11. An apparatus for converting surface properties, integrally comprising:
a concealing-image forming unit that forms a concealing image on a recording medium using an ink composition containing hollow resin particles; and
a hollow-resin-particle breaking unit that breaks the hollow resin particles contained in the concealing image.
